(19) United States
(12) Patent Application Publication
(10) Pub. No.: US 2004/0163746 A1
(43) Pub. Date: Aug. 26, 2004

(54) Installation of non-round anti-slip studs in a vehicle tire

(75) Inventor: Pentti Juhani Eromaki, Nokia (FI)

Correspondence Address: KLARQUIST SPARKMAN, LLP, 121 SW SALMON STREET, SUITE 1600, PORTLAND, OR, 97204, US

(73) Assignee: Nokian Tyres PLC

(21) Appl. No.: 10/728,084

(22) Filed: Dec. 3, 2003

(30) Foreign Application Priority Data
Dec. 11, 2002 (FI) 20022179

(51) Int. Cl. B60C 11/16; B29D 30/66

(52) U.S. Cl. 152/210; 156/114; 29/894.37

(57) ABSTRACT

The invention relates to a combination for installing anti-slip studs in an air-filled vehicle tire provided with a tread and a number of premade stud recesses. The combination includes anti-slip studs with an inner head provided with a bottom flange and an outer head provided with a top bowl, and therebetween a narrower neck portion. In the anti-slip studs at least the shape of the bottom flange is composed of a number of two or more first side portions, the center regions of which are located at a shorter distance from the stud center line, and of a number of two or more edge portions and/or of a number of two or more second side portions, the center regions of which are located at a longer distance from said stud center line. In addition, the combination includes an installation tool comprising a number of jaw fingers, said number being equal to the number of said edge portions, or twice the number of the second side portions, by which installation tool the anti-slip studs are installed in said tread.

This application claims the benefit under 35 U.S.C. § 119 of the earlier filing date of Finnish Application No. 20022179, filed on Dec. 11, 2002.

### FIELD

The invention relates to a combination for installing anti-slip studs, said combination comprising: an air-filled vehicle tire that has a tread with a rolling surface; anti-slip studs, constituting an outer head and an inner head, the inner head being provided with a bottom flange, the outer head being provided with a top bowl and a narrower neck portion therebetween; in the tread, the bottom flange is positioned deeper with respect to the rolling surface, and the top bowl is positioned nearer to the rolling surface; said anti-slip studs having a stud length and a stud center line parallel to said stud length, as well as a cross-sectional shape perpendicular to said stud center line; which cross-sectional shape, at least in one portion of said stud length, essentially deviates from a round shape; and an installation tool by which said anti-slip studs are installed in said tread.

### BACKGROUND

The publication RU-2 1591 84 describes a method and device for installing anti-skid studs in a vehicle tire, for which purpose stud holes are drilled in the tire tread flanges. The anti-skid studs are first attached in a cylindrical holder, and the stud is brought in the hole by rotating the holder by an eccentric circular motion with a shift not exceeding the hole diameter, and/or by rotating the holder in a cone-like fashion, with an angle at the vertex not exceeding 200, and by simultaneously working the anti-skid stud deeper into the hole, until it reaches the hole bottom, whereafter the holder is extracted from the hole. This kind of device can only be used for installing round anti-skid studs, and owing to the rotary motion, they are set in random positions in the stud holes. Any orientated installation of non-round anti-skid studs, such as those described in the publications US-2002/0050312 and DE-24 00 999, and anti-skid studs containing non-round hard metal core, such as those described in the publication US-2002/0050312, i.e. the arrangement of an asymmetry direction of the studs in a predetermined position, for instance with respect to the rotation level of the tire, is not possible by means of the method or device of said publication.

The publication DE-24 00 999 discloses an anti-skid stud made of one single material, said stud being oval in cross-section and in the lengthwise direction nearly wedge-shaped, and the publication JP-58-012806 discloses an anti-slip spike made of one single material, said spike being polygonal in cross-section, so that particularly the contact surface of the spike tip is polygonal in shape, and in the lengthwise direction it is formed of a bottom flange and a homogeneously thick shank part. This type of studs are strongly inclined inside the tire when driving, especially if the tire tread is made of relatively soft rubber, as is the case nowadays, which means that the tire grip is remarkably reduced, and the studs may even be detached. If this kind of an anti-skid stud is made of a sufficiently hard, impact-resistant and wear-resistant hard metal, it becomes remarkably heavy, which means that the road surface is heavily worn, and the rubber tread of the tire is damaged easily and rapidly. Neither of the above described publications mentions possible orientation of the stud in the tire, nor do they discuss stud installation devices or installation methods in the tire tread. In the publication FI-9/65, there is described a stud composed of one single hard metal piece that is partly shaped as a round bottom flange and partly as a tip element. The tip element has the shape of a polygon, most advantageously with three or four sides, and in addition these sides are concave, and the outmost parts of the tip element are convex surfaces. Also this kind of stud becomes heavy in weight, and owing to the round-shaped bottom flange, it is set in random positions in the tire.

The publication DE-1 605 598 describes an anti-skid stud where the body comprises an elongate bottom flange, a round hard metal pin protruding from the body, and in the hard metal side of the body a thick expansion that is remarkably wider than the shorter diameter of the bottom flange, which expansion is provided with grooves and ridges in the circumferential direction of the stud, for instance cogged shapes or fir-tree shapes. The bottom flange has the described elongate shape because excessive stretching of the rubber material in the tire tread is thus more easily avoided when installing studs in the stud hole. The publication also describes a stud installation tool particularly comprising only two thin-tip jaws, where the mutually facing inner surfaces of the jaws are partly parallel, partly concave, and the jaws stretch the stud hole on purpose in one direction only. The studs are pressed in the stud hole between two jaws by using a quadrangular pin.

In the publication US-2002/0050312 there are described studs that have an elongate bottom part, other than round in form, said deviant form having a lengthwise axis; as well as an elongate top part, other than round in form, said deviant form also having a lengthwise axis; the lengthwise axes of the bottom and top parts are mutually reversed, so that the lengthwise axis of the top part and the lengthwise axis of the bottom part close an angle other than zero, said angle preferably being between 65° and 115°. According to said publication, this type of studs are shot in the tire tread while it is in a non-vulcanized state by using an injection tube with an ellipsoidal cross-section, so that in the middle of the running surfaces of the tires, the lengthwise axes of the stud tops are arranged in the circumferential direction of the tire, whereas in the border areas of the running surfaces, the lengthwise axes of the stud tops preferably form an angle of 45° with the circumferential tire direction, and the lengthwise axes of the bottom parts preferably form an angle of 25° with the circumferential tire direction. When the studs are designed in this way, their positioning in the correct direction in automatic installation machines is not reliable, but the studs may arrive upside down in the injection tubes. Moreover, the vulcanizing of a tire already provided with studs is extremely difficult and expensive, and it results in a large amount of defective and consequently discarded tires in production.

For instance in the publication U.S. Pat. No. 3,385,742, there is described how anti-skid studs are inserted in a vehicle tire provided with stud holes. The insertion tool includes three jaw fingers with narrowing tip parts, said jaw fingers being radially movable, and a plunger that moves in the space left between the jaw fingers. When inserting the studs, the jaw fingers are pushed in the stud hole, the anti-skid studs are fed in between the jaws and pressed by the plunger into the stud hole; the jaw fingers expand the stud hole while the plunger holds the anti-skid stud in the stud hole, as the jaw fingers are pulled out of the stud hole and from around the anti-skid stud. In the publications, however, the studs themselves are round in cross-section, which means that in the embodiment described in said publication, the three jaw fingers only affect the central aligning of the stud and consequently its hitting the stud hole; any kind of orientation of the stud is not possible, and in any case it has no significance when dealing with round-shaped studs.

In the figures presented in the publication RU-2 152 318, there can be seen the jaws of the installation tool, but the only thing that is said of them in the text is that they are only used for enlarging the stud hole. However, from the figures it can be concluded that the number of jaws is exactly two, which also is supported by the fact that in the above mentioned German publication DE-1 605 598, where the stud has a similar type of bottom flange as in the figures of this RU publication, there also are provided only two jaws. Moreover, according to the publication the studs are orientated by a control tube that has a shape conforming to the shape of the stud, and the stud orientation takes place exactly in the same way as in the above mentioned publication US-2002/0050312. In said RU publication, there are used—unlike in said US publication where a cylindrical plunger was used—three plungers, by which the anti-skid stud is pressed along the control tube and to between the jaws at that surface of the stud flange that points to the protruding direction of the hard metal piece. These plungers do not have—and cannot have—any function affecting in the orientation of the stud; on the contrary, the jaws must not under any circumstances affect the stud orientation, or else the stud position achieved by the control tube is lost.

### SUMMARY

Thus the main object of the invention is to realize a non-round anti-slip stud and its installation tool, by which, when used together, i.e. as a combination, there can be studded a vehicle tire tread—provided with stud recesses that are made already during vulcanization in a fashion known from round studs—by studs other than round in shape, so that a predetermined direction or dimension, representing a non-round notion, can in each case be arranged at a desired angle with respect to the tire rotation level, i.e. so that the anti-slip stud can be orientated. Another object of the invention is to realize a described non-round anti-slip stud and its installation tool combination by which the above mentioned orientation, i.e. the angle between the direction or dimension representing the non-round shape of the stud and the tire rotation level can be adjusted, according to the desired size of said angle, in a rapid and easy fashion. A third object of the invention is to realize for the described combination an installation tool that can in a simple fashion be adjusted to match precisely with various types of studs that vary as regards their non-round shape. Yet another object of the invention is to realize a non-round anti-slip stud and its installation tool combination that is reliable in operation, easy to use and economical to purchase.

The above described drawbacks can be eliminated and the above enlisted objects achieved by means of a combination according to the invention, as well as by means of the method according to the invention.

According to the first alternative of the invention the combination for installing anti-slip studs comprises: an air-filled vehicle tire, provided with a tread with a rolling surface; anti-slip studs provided with an outer head and an inner head, and in the inner head a bottom flange and in the outer head a top bowl, the bottom flange in the tread being deeper from the rolling surface and the top bowl being nearer to the rolling surface; said anti-slip studs having a stud length and a stud center line parallel to said stud length, and the bottom flange having a cross-sectional shape perpendicular to the stud center line, which cross-sectional shape is composed of: a number of at least two first side portions with center regions at a shorter distance from said stud center line, and a number of at least two second side portions with center regions at a longer distance from said stud center line; and an installation tool by which said anti-slip studs are installed in said tread. In this case said combination further comprises: a plurality of premade stud recesses in said tread; a number of jaw fingers in said installation tool, which number is equal to twice the number of said second side portions; and said jaw fingers being in contact with at least two such first side portions of the bottom flange of the anti-slip stud where said center regions are located at a shortest distance from said stud center line, in order to keep the bottom flange and hence the anti-slip stud in a predetermined constant position between said jaw fingers. Here the first type of bottom flange configuration is utilized together with the jaw fingers of installation tool to attain a predetermined orientation of the anti-slip studs in respect to the rotation axis line of the tire.

According to the second alternative of the invention the combination for installing anti-slip studs comprises: an air-filled vehicle tire, provided with a tread with a rolling surface, and a plurality of premade stud recesses in the tread; anti-slip studs, provided with an outer head and an inner head, and in the inner head a bottom flange and in the outer head a top bowl, the bottom flange in the tread being deeper from the rolling surface and the top bowl being nearer to the rolling surface; said anti-slip studs having a stud length and a stud center line parallel to said stud length, and the bottom flange having a cross-sectional shape perpendicular to the stud center line, which cross-sectional shape is composed of: a number of at least two first side portions with center regions at a shorter distance from said stud center line, and of a number of at least two edge portions; and an installation tool by which said anti-slip studs are installed in said tread. In this case said combination further comprises: a number of jaw fingers in said installation tool, which number is equal to the number of said edge portions; and said jaw fingers being in contact with at least two such first side portions of the bottom flange of the anti-slip stud where said center regions are located at a shortest distance from said stud center line, in order to keep the bottom flange and hence the anti-slip stud in a predetermined constant position between said jaw fingers. Here the second type of bottom flange configuration is utilized together with the jaw fingers of installation tool to attain a predetermined orientation of the anti-slip studs in respect to the rotation axis line of the tire.

The method according to the invention for installing non-round anti-slip studs in a vehicle tire tread comprises the steps of: providing an air-filled vehicle tire with a tread and a plurality of premade stud recesses in the tread, said tire having a rotation axis line; utilizing an installation tool comprising: a number of at least three jaw fingers provided with narrowing tip portions, said jaw fingers being radially movable along their mutual jaw center line and radially away therefrom, and a plunger pin that is movable in parallel with the jaw center line and in the mutual interval between the jaw fingers; inserting said tip portions of the installation tool in said stud recesses, one recess at a time; entering an anti-slip stud provided with a top bowl and a bottom flange in the mutual interval, so that the bottom flange proceeds foremost; pressing said anti-slip stud by a plunger pin into the stud recess, along said mutual interval, so that the jaw fingers expand the stud recess; allowing said plunger pin to hold the anti-slip stud in the recess at the same time as the jaw fingers are pulled out of the stud recess, from around the anti-slip stud; and proceeding to install the next anti-slip stud in the next stud recess, or terminating the installation of the studs in this tire. According to the third alternative of the invention, the method further comprises the steps of: using anti-slip studs of a type having an oval or polygonal bottom flange that is at least partly wider than said top bowl, and with a non-round hard cermet piece arranged on a cross-sectional plane perpendicular to the stud center line, said shape of the hard cermet piece being in a constant position with respect to the shape of the bottom flange; and turning at least the jaw fingers of the installation tool around the jaw center line by a predetermined toe-out angle or without said toe-out angle in respect to said rotation axis line of the tire, in order to orientate the hard cermet piece of the studs in a predetermined position in the tire with respect to said rotation axis line. Here one type of anti-slip studs with a relationship between the bottom flange and the hard cermet piece is utilized together with the rotated jaw fingers of installation tool to attain predetermined orientations of the anti-slip studs in respect to the rotation axis line of the tire. According to the fourth alternative of the invention, the method further comprises the steps of: using anti-slip studs of a type having an oval or polygonal bottom flange that is at least partly wider than said top bowl, and a hard cermet piece that is non-round on the cross-sectional plane perpendicular to the stud center line; maintaining at least the position of the jaw fingers of the installation tool in a constant position in respect to said rotation axis line of the tire; and changing the type of the anti-slip studs to be installed, so that studs where the shape of the hard cermet piece is rotated by a predetermined toe-out angle with respect to the shape of the bottom flange are replaced by studs where said toe-out angle does not exist, or vice versa, in order to orientate the hard cermet piece of the studs in a predetermined position in the tire with respect to said rotation axis line. Here a stud family including at least two types of anti-slip studs with different relationships between the bottom flange and the hard cermet piece is utilized together with the jaw fingers of installation tool to attain predetermined orientations of the anti-slip studs in respect to the rotation axis line of the tire.

### BRIEF DESCRIPTION OF THE DRAWINGS

The invention is described in more detail below with reference to the appended drawings.

FIGS. 1A and 3A illustrate first embodiments of the orientations of anti-slip studs according to the invention, provided with a quadrangular hard cermet piece and a bottom flange, in the vicinity of the first and respectively the second shoulder of the tire, at points I and III in FIG. 4, but in a larger scale. Here the first embodiments of the orientations are achieved by applying the second installation method of the invention.

FIGS. 1B and 3B illustrate first embodiments of the orientations of anti-slip studs according to the invention, provided with a quadrangular hard cermet piece and a bottom flange, in the vicinity of the first and respectively the second shoulder of the tire, at points I and III in FIG. 4, but in a larger scale. Here the first embodiments of the orientations are achieved by using the first installation method of the invention.

FIG. 2 illustrates a first embodiment of the orientations of anti-slip studs according to the invention, provided with a quadrangular hard cermet piece and a bottom flange, nearer to the center regions of the tire than in FIGS. 1 and 2, at point II in FIG. 4, but in a larger scale. As an alternative, the figure illustrates a second embodiment of the orientations of anti-slip studs according to the invention, provided with a quadrangular hard cermet piece and a bottom flange, in various regions of the tire width, at points I, II and III in FIG. 4, but in a larger scale.

FIG. 4 is an overall illustration of an air-filled vehicle tire tread and of the positions of anti-slip studs when seen from the outside, corresponding to the direction IV in FIGS. 16A-16D.

FIG. 5 illustrates an embodiment according to the invention of an anti-slip stud provided with a hexagonal bottom flange and an elongate hard cermet piece, as well as six jaw fingers that match with said hexagonal flange, by which jaw fingers the orientating installation of the studs is carried out, seen from the side of the hard cermet piece, corresponding to the direction IV of FIGS. 16A-16D.

FIG. 6 illustrates an embodiment according to the invention of an anti-slip stud provided with a pentagonal bottom flange and an elongate hard cermet piece, as well as five jaw fingers that match with said pentagonal bottom flange, by which jaw fingers the orientating installation of the studs is carried out, seen from the side of the hard cermet piece, corresponding to the direction IV of FIGS. 16A-16D.

FIG. 7 illustrates a first embodiment according to the invention of an anti-slip stud provided with a triangular bottom flange and an elongate hard cermet piece, as well as four jaw fingers that match with said triangular bottom flange, by which jaw fingers the orientating installation of the studs is carried out, seen from the side of the hard cermet piece, corresponding to the direction IV of FIGS. 16A-16D.

FIGS. 8-10 illustrate a first, second and third embodiment according to the invention of an anti-slip stud provided with a quadrangular bottom flange and an elongate hard cermet piece, as well as four jaw fingers that match with said quadrangular bottom flange, by which jaw fingers the orientating installation of the studs is carried out, seen from the side of the hard cermet piece, corresponding to the direction IV of FIGS. 16A-16D.

FIGS. 11-13 illustrate a first, second and third embodiment according to the invention of an anti-slip stud provided with an oval bottom flange and an elongate hard cermet piece, as well as four jaw fingers that match with said oval bottom flange, by which jaw fingers the orientating installation of the studs is carried out, seen from the side of the hard cermet piece, corresponding to the direction IV of FIGS. 16A-16D.

FIG. 14 illustrates a second embodiment according to the invention of an anti-slip stud provided with a triangular bottom flange and an elongate hard cermet piece, as well as three jaw fingers that match with said triangular bottom flange, by which jaw fingers the orientating installation according to the invention of the stud is carried out, seen in their inner position for inserting the stud in the stud recess, and in the outer position for expanding the stud recess in order to insert the anti-slip stud in the stud recess, seen from the side of the hard cermet piece, corresponding to the direction IV of FIGS. 16A-16D.

FIG. 15 illustrates a fourth embodiment according to the invention of an anti-slip stud provided with a quadrangular bottom flange and a quadrangular hard cermet piece, as well as four jaw fingers that match with said quadrangular bottom flange, by which jaw fingers the orientating installation of the stud is carried out, as well as a plunger pin that pushes the anti-slip stud in the recess, seen in an axonometric view.

FIGS. 16A-16D illustrate, as steps of the installation method according to the invention: jaw fingers in their inner position, ready for the installation outside the stud recess; jaw fingers in their inner position, inserted in the stud recess, while the anti-slip stud is ready to be pushed in the stud recess; jaw fingers in their outer position, expanding the stud recess, and the anti-slip stud as held by the plunger pin in the stud recess; and the anti-slip stud in the stud recess and the and jaw fingers as pulled out of the stud recess, seen in a cross-section perpendicular to the tire tread surface, along the plane V-V of FIGS. 8, 12, 14 and 15.

FIG. 17 illustrates a round embodiment of a stud hole provided in a tire studded according to the invention, seen from outside the tire tread, in a similar view as in FIG. 4, but in a larger scale, corresponding to the direction IV of FIGS. 16A-16D.

FIG. 18 illustrates an oval embodiment of a stud hole provided in a tire studded according to the invention, seen from outside the tire tread, in a similar view as in FIG. 4, but in a larger scale, corresponding to the direction IV of FIGS. 16A-16D.

FIGS. 19 and 20 illustrate two embodiments according to the invention of an anti-slip stud provided with a triangular bottom flange and a triangular hard cermet piece, as well as three jaw fingers matching with said triangular bottom flange, by which jaw fingers the orientating stud installation according to the invention is carried out, seen from the side of the hard cermet piece, corresponding to the direction IV of FIGS. 16A-16D.

### DETAILED DESCRIPTION

The figures illustrate a combination for the installation of anti-slip studs in vehicle tires. For this purpose, the combination includes first of all an air-filled vehicle tire 40, provided with a tread 41 that has a rolling surface 42; in said tire tread, there are installed anti-slip studs 20 constituting an outer head 31 and an inner head 32. The inner head of the stud 20 is provided with a bottom flange 22, and the outer head is provided with a top bowl 21, and between these two there is arranged, preferably but not necessarily, a neck portion 23 that is narrower than both the top bowl and the bottom flange. In average, the diameters of the neck portion 23 are not more than 90%, preferably not more than 85% of the diameters of the top bowl 21 or the bottom flange 22, i.e. of the smaller of these two, in directions perpendicular to the stud center line. In case the anti-slip stud is not provided with a neck portion, the top bowl extends, being at least nearly homogeneous in thickness, from the bottom flange 22 to the outer head 31. When the stud is installed in the tread, its bottom flange in the tread is positioned deeper, further from the rolling surface, and the top bowl is positioned nearer to the rolling surface 42. Said anti-slip studs have a stud length L_{T}, a stud center line 30 parallel to said stud length, as well as a cross-sectional shape perpendicular to said stud center line, which cross-sectional shape, at least in one portion L_{P} of the stud length, essentially deviates from circular. Further, the combination comprises an installation tool 1, by which said anti-slip studs are installed in said tread.

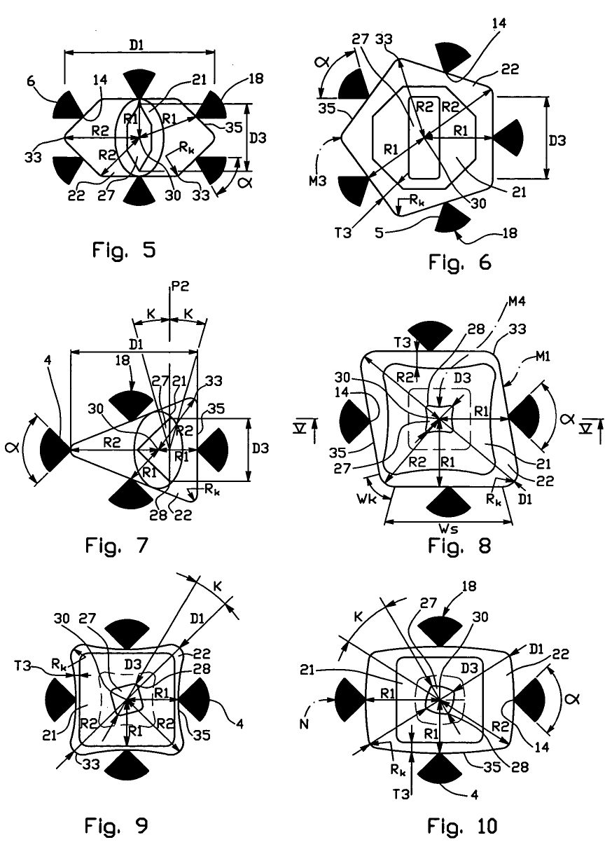

According to the invention, the tire tread 41 included in the combination is provided with stud recesses 43 made in advance, i.e. the stud recesses are made in the tire during vulcanization, by means of stud pins arranged in the vulcanization mold; these stud pins can represent any suitable known or new type that is therefore not explained in more detail here. However, the stud recesses 43 are preferably, although not necessarily, provided with a bottom expansion 44 for the bottom flange 22 of the anti-slip studs, and the stud recesses 43 are provided with an at least partly circular inner surface with a hole diameter D_{H} and/or a bottom expansion 44 that has an essentially similar shape as the bottom flange 22 of the anti-slip stud. Consequently, the cross-sectional shape of the outer part 45 of the stud recess, in which the top bowl 21 of the stud 20 is set, is typically circular, as is shown in FIG. 17, but it can also be elongate in cross-section, thus corresponding for example the elongate cross-sectional shape of the top bowl according to FIGS. 5, 7, 11 and 13, as is shown in FIG. 18. As regards the stud recesses 43, at least the transversal diameter D_{H} of the outer part 45 is essentially smaller than the transversal diameter D_{S} corresponding to the top bowl 21 of the anti-slip stud 20; advantageously the transversal diameter D_{H} of the stud recess is less than 60% of the corresponding transversal diameter D_{S} of the anti-slip stud, and typically not more than 40% of the corresponding diameter D_{S} of the anti-slip stud. Typically also the bottom expansion 44 is smaller in transversal diameters than the bottom flange 22. In the description above, we have naturally compared post-vulcanization stud recess dimensions, in free state without a stud arranged therein, with the dimensions of the anti-slip stud. As regards the bottom expansion 44 of the stud recess, it advantageously has a nearly similar shape in a cross-section that is perpendicular to the stud length L_{L} and to the stud center line 30 as the shape of the bottom flange of the anti-slip stud meant for said stud recess in a direction perpendicular to the stud length L_{T} and at the same to the stud center line 30. Thus the bottom expansion 44 can be circular, as is shown in FIG. 17, in which case it has a transversal diameter W3, or oval, as is shown in FIG. 18, in which case the bottom expansion has in the direction of the rolling surface 42 a larger length W1 than width W2. The vehicle tire 40 has a rotation direction P1 or, in a case where the rotational direction has no significance, a circumferential rotation direction P1 defined thereby, which is perpendicular to the rotational axis line P2.

According to the invention, in the anti-slip studs 20 included in the combination, at least the cross-sectional shape of the bottom flange 22, being essentially deviant from circular, in the direction perpendicular to the stud length L_{T} and at the same time to the stud center line 30, is compiled of M1 numbers of two or more first side portions 35, the center areas of which are located at a shorter distance R1 from said stud center line 30, and of M3 numbers of two or more edge portions 33 and/or of M2 numbers of two or more second side portions 32, the center areas of which are located at a longer distance R2 from said stud center line 30. More precisely, the longer distance R2 is thus longer than the shorter distance, i.e. R2>R1. The edge portions 33 can be distinguished from the rest of the side portions 32 in that the distance of the bottom flange edge from the center line 30 grows as we proceed from a point of the second side portion 32, corresponding to the longer distance R2, to either direction or to any of these two directions along the bottom flange edge, whereas the distance of the bottom flange edge from the center line 30 is shortened or does not stay the same longer than for a short while, as we proceed from the most central point of the edge portion 33, corresponding to the longer distance R2, to either direction along the edge of the bottom flange. In addition, it is pointed out that said first side portions 35 have a first curvature, and that said edge portions 33, as well as the second side portions 32 have a second curvature. Here the term “curvature” means, in conventional fashion, the derivative of the direction angle of the tangent of a curve with respect to curve length, so that the first curvature of the straight side portions of the bottom flange, as in the bottom flanges of FIGS. 5-8, has value zero, and the first curvature of the convex side portions of the bottom flange, as in the bottom flanges of FIGS. 10 and 11-13, and of the concave side portions, as in the bottom flanges of FIG. 9, has a relatively small positive or negative value. Thus the first side portions 35 can in all cases be either straight or convex or concave. As for the second curvature of the edge portions and second side portions, it has a relatively large value, in which case the value, as the edge changes from rounded to sharp, approaches infinite. However, the edge portions 33 preferably have a radius of curvature R_{K}, which means that their curvature is smaller than infinite. Now it is assumed that the second curvature value must be at least double in comparison with the first curvature value. It can also be maintained that the difference between the edge portions 33 and the second side portions 32 is only slight, so that the absolute value of the second curvature of the edge portions 33 is larger than the absolute value of the second curvature of the second side portions 32. Apart from the curvatures and their differences, the curve lengths of both the edge portions or the second side portions and the curve lengths of the first side portions 35 affect in whether the bottom flange in question is an oval or polygonal bottom flange 22 according to the invention. Particularly the number M3 of the edge portions 33 is at least three, in which case there is formed a triangular bottom flange 22, but not more than six, in which case there is thus formed a hexagonal bottom flange 22, for the reason that in the case of a larger number, and when the hard cermet piece has the same number M4 of edges 28 as the bottom flange, the anti-slip stud has practically the same properties as a round anti-slip stud, which means that the orientation according to the invention, i.e. the arranging of the largest diameter D3 or the largest width D3 of the hard cermet piece 27 in a given, predetermined position with respect to the circumferential rotation direction P1 and the rotational axis line P2 is not required. Advantageously the number M3 of the edge portions 33 is four. In a case where the second side portions 32 gradually or steplessly change into said first side portions 35, the second side portions 32 and the first side portions 35 together form an oval-shaped bottom flange 22. As can be seen by comparing FIGS. 5 and 11, the limit between an oval and a polygonal bottom flange is flexible, when the value of the radius of curvature R_{K} approaches the value of the curvature of the adjacent first side portions 35, or when the curve length W_{K} of the edge portions 33 that have a radius of curvature R_{K} approaches the distance W_{S} between the edge portions. Advantageously the edges of the bottom flange 22 of the anti-slip stud 20 are provided with bevels 25 pointing away from the hard cermet piece 27, by which bevels the anti-slip stud in the studding operation to be described below is inserted from between the jaw fingers into the stud recess, proceeding so that first at the front, in the hole inserting direction F2, there is a form that is slightly conical or wedge-like in the crosswise directions, or spherical or toroidal or the like, depending whether the bevel 25 is straight, convex or concave.

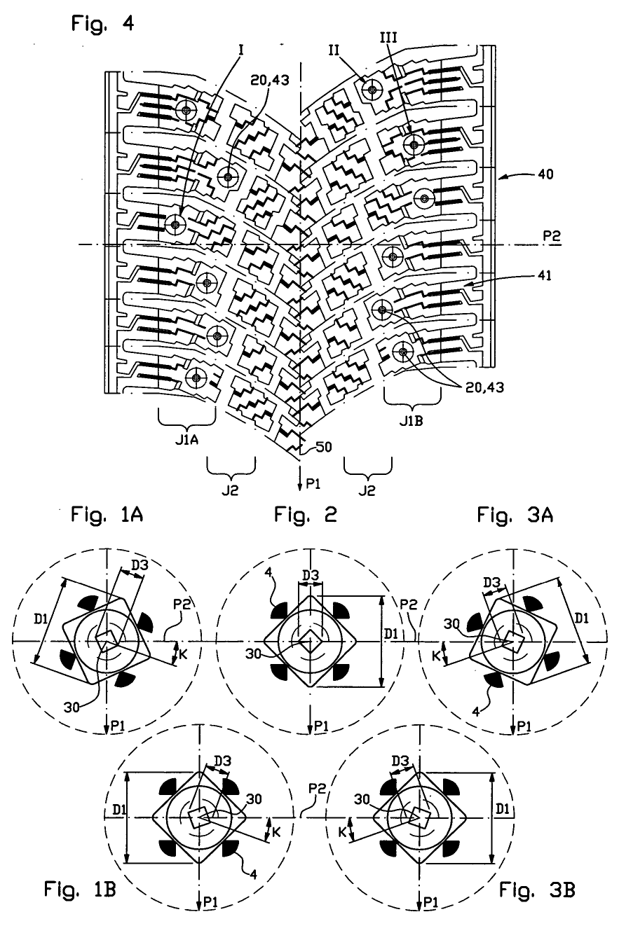

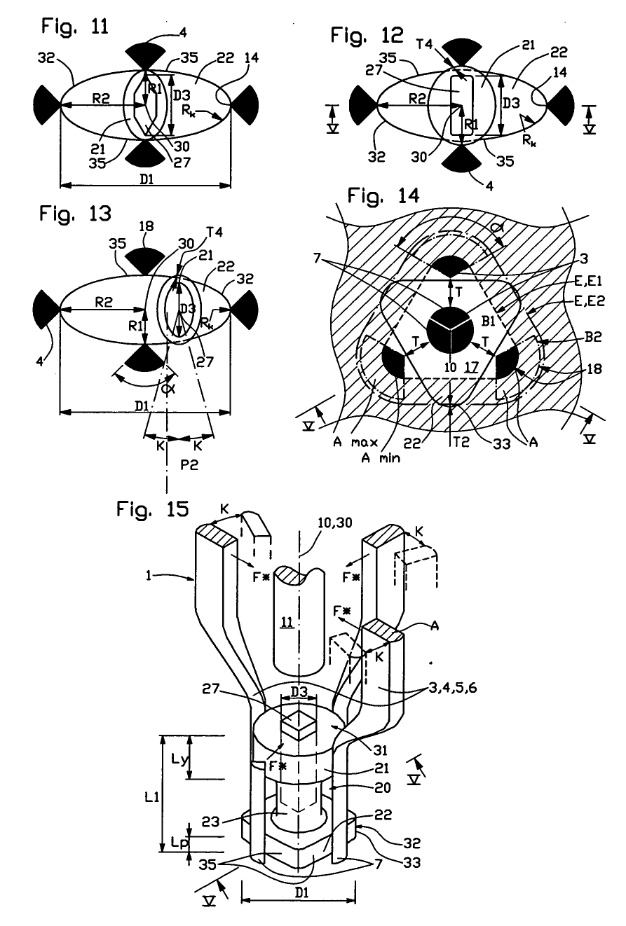

Advantageously the diameters of the top bowl 21 of the anti-slip stud 20 are at the most as large as the corresponding dimensions of the bottom flange 22, all in a direction perpendicular to the stud center line 30. More precisely, in the direction of the stud center line 30 the projection of the top bowl 21 is preferably completely located inside the projection of the bottom flange 22 that is parallel with the stud center line, but not more than only slightly, i.e. for the measure of the first tolerance T3. Consequently, in a preferred embodiment, the top bowl projection, i.e. the projection contour, tangentially touches the bottom flange projection, i.e. projection contour, as is seen in FIGS. 5, 7 and 11, or the top bowl projection, i.e. the projection contour, can be located inside the bottom flange projection, i.e. the projection contour, for the measure of the first tolerance T3, as is seen in FIGS. 1A-3B, 6 and 8-10. It is also allowed, although not preferable, that the top bowl projection, i.e. projection contour, is located outside the bottom flange projection, i.e. projection contour, for the measure of a local second tolerance T4, as is seen in FIGS. 12-13. In any case, the first tolerance T3 and the local second tolerance T4, if they are applied, are small with respect to the stud dimensions, i.e. they are not more than 15%, typically not more than 10% and preferably not more than 5% of the bottom flange diameter at the tolerance in question and via the stud center line. In a situation where the projection of the top bowl 21 extends to outside the projection of the bottom flange 22 only in the areas between the jaw fingers 3 or 4 or 5 or 6, but not at the jaw fingers, as in FIG. 13, a second tolerance T4 larger than what is said above can be allowed. The second tolerance T4 may occur only locally, which means that it must not be extended over the whole circumference of the stud, and at the moment it is believed that it may not occur at more than half of the number N of the jaw fingers, as brought down to a full figure, i.e. in the case of three jaw fingers, at no more than one, in the case of four and five jaw fingers, at no more than two, and in the case of six jaw fingers, at no more than three.

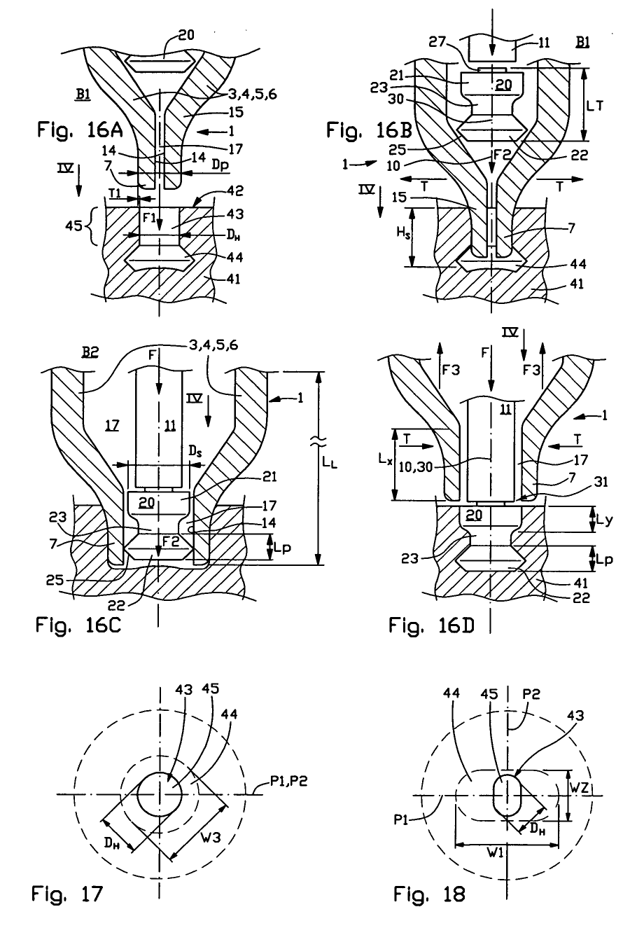

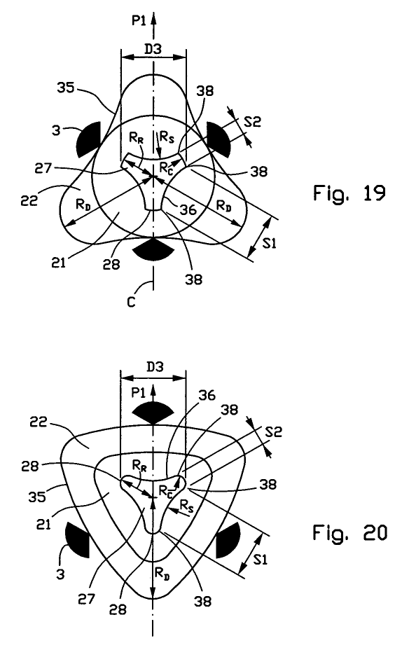

According to the invention, the installation tool 1 included in the combination comprises a number N of jaw fingers 3, 4, 5, 6, which number is equal to the number M3 of said edge portions, or doubly the number M2 of the second side portions. When the number M3 of the edge portions 33 is three, the number N of the jaw fingers 3 is consequently three, as is seen in FIG. 14, or four, as is seen in FIG. 7. When the number M3 of the edge portions 33 is four, the number N of the jaw fingers 4 is four, as is seen in FIGS. 8-10. When the number M3 of the edge portions 33 is five, the number N of the jaw fingers 5 is five, as is seen in FIG. 6. When the number M3 of the edge portions 33 is six, the number N of the jaw fingers 6 is six, as is seen in FIG. 5. When the number M2 of the second side portions 32 is two, the number N of the jaw fingers 4 is four, as is seen in FIGS. 11-13. The shape in principle of the jaw fingers 3, 4, 5, 6 of the installation tool 1 is understood from FIGS. 14-16D. In other words, the number of the jaw fingers in any case is at least three. The jaw fingers have a jaw length L_{L} that is essentially longer than the stud length L_{T} of the anti-slip studs, and a mutual jaw center line 10 that essentially concurs with the stud center line 30 of the anti-slip studs to be installed. The jaw fingers are arranged towards said jaw center line and away therefrom as radially movable in directions T. The jaw fingers 3, 4, 5, 6 of the installation tool 1 have tip portions 7 that are narrowed in the direction of the jaw length L_{L}, and the tip point diameter D_{P} together formed by said tip portions 7 is, as the jaw fingers are arranged in the position B1, where they are pointed towards the jaw center line 10 and in contact with each other, longer than said hole diameter D_{H}, but not more than for the measure of the first tolerance T1. This is clearly understood from FIGS. 14 and 16A. In the direction of the jaw lengths L_{L}, the jaw fingers 3, 4, 5, 6 of the installation tool 1 have cross-sections A that are radially thickening in the direction of the tip portions 7 with respect to the jaw center line 10, i.e. in FIG. 14 the smallest cross-section A_{MIN} of the tip portions 7 is described by a through black color, and in the position B2 where the tip portions are shifted away from each other, the addition in the area within the range defined by the angle of point a, at the top jaw point 15, away from the jaw center line 10, is marked with a dotted line, which extension further away from the jaw center line is also seen in FIGS. 16A-16D. The enlarged cross-section A_{MAX}, i.e. the sum of the smallest cross-section and its expansion, is located essentially at the distance of the depth H_{S} of the stud recess from the outer head of the tip portion of the jaw fingers. For the changing cross-sections, there is used the common reference number A, and A_{MIN} as well as A_{MAX} are special cases of said cross-sections. With the length L_{X} of the tip portions 7, the jaw fingers 3, 4, 5, 6 are designed to be narrowing in a wedge-like fashion towards the jaw center line 10, so that there is created a contact edge 14, and the angle of point a is positioned between the sides of said contact edge 14. Advantageously the angle of point a is in the case of three jaw fingers 3 essentially 120°, in the case of four jaw fingers 4 essentially 90°, in the case of five jaw fingers 5 essentially 72° and in the case of six jaw fingers 6 essentially 60°, so that the jaw fingers, when pressed together in the radial direction T, form a uniform entity, i.e. generally the angle of point α≅360°/N. In any case, the angle of point a of the jaw fingers, which angle is located on a plane perpendicular to the common jaw center line 10 of the fingers, thus creating the contact edge 14 of the jaw fingers that are in contact with the anti-slip stud, is remarkably smaller than 180°, however preferably not larger than 150°. The outer circumferences 18 of the jaw fingers 3, 4, 5, 6 are designed so that while they are pressed together in the radial direction T, they together form a shape that more or less corresponds to the cross-sectional shape of the outer part 45 of the stud recess, such as a circle or an oval etc. The installation tool 1 also comprises a plunger pin 11 that is arranged to move in the direction of the jaw center line 10, at said line, to the common interval 17 of the jaw fingers 3, 4, 5, 6, when the jaw fingers are radially shifted away from each other, as can be understood from FIGS. 16C-16D.

Because the jaw fingers 3, 4, 5, 6 are in contact with at least two such first side portions 35 of the bottom flange 22 of the anti-slip stud 20 where the center regions are at the distance of the smaller distance R1 from the stud center line 30, the bottom flange and hence the whole stud remain effectively in the correct, desired and always in the same position between the jaw fingers. This is understandable, if we observe that in the situation of FIGS. 1A-15, we should try and turn the stud around its center line, so that the straight, slightly convex or slightly concave side of the bottom flange 22 should, in order to make the stud turn, be capable of pushing at least two opposite jaw fingers away from each other, which owing to the locally occurring momentum transmission geometry—is extremely inefficient and hence is not realized in practice. The jaw fingers 3, 4, 5, 6 are charged by the force F* against each other, which power can be generated by any suitable known or new way, such as by springs, pneumatics or possibly hydraulics not illustrated in the drawings, which methods, as representing the prior art, are not described in more detail here. If the jaw fingers are in contact with only the two first side portions 35, there is additionally at least one jaw finger in contact with one edge portion 33 or possibly with one of the second side portions 32. In case there is used a minimum number of jaw fingers, i.e. three jaw fingers 3, it is, however, more advantageous to arrange said jaw fingers to be in contact with three first side portions 35, if the bottom flange is provided with said side portions, as is shown in FIG. 14. This kind of arrangement with three jaw fingers is suited, apart from a triangular bottom flange that is naturally provided with three first side portions, also at least to a pentagonal bottom flange and a hexagonal bottom flange. If there are used four jaw fingers 4 or more jaw fingers 5, 6, they can all during the installation process get into contact with the first side portions 35, as is seen in FIGS. 5, 6 and 8-9, or at least two jaw fingers can get into contact with the first side portions 35, and the rest of the jaw fingers can get into contact with the edge portions 33, as is seen in FIG. 7, or with the second side portions 32, as is seen in FIGS. 11-15, or both with the edge portions and with the second side portions. It is also pointed out that the jaws 3, 4, 5, 6, irrespective of their number, need not be positioned and/or located symmetrically around the stud center line 30.

In addition, the anti-slip stud 20 comprises a separate hard cermet piece 27 that extends from said outer head 31 to at least the length L_{Y} of the top bowl 21 and has a non-round cross-sectional shape in a plane perpendicular to the stud center line 30. According to a first alternative, said non-round cross-sectional shape of the hard cermet piece 27 is essentially a triangle or a quadrangle or a pentagon or a hexagon, having a longest diameter D3 and is located in the anti-slip stud 20, with respect to the triangular or quadrangular or pentagonal or hexagonal shape of the bottom flange 22, either essentially in the same position, in the way illustrated in FIGS. 7-8, or rotated for the degree of the toe-out angle K, in the way illustrated in FIGS. 9-10. In this toe-out case, one of the longest diameters of said polygonal shape thus forms the toe-out angle, when one of the longer distances R2 or two longest distances of the bottom flange 22 are parallel with the longest diameter D1, such as the diagonal, formed by them together. Said non-round cross-sectional shape of the hard cermet piece 27 is, according to the second alternative, essentially elongate, in which case it can also be—in a way defined above—a triangle or a quadrangle or a pentagon or a hexagon, having a largest width D3 and being located in the anti-slip stud 20, so that the largest width D3 is, with respect to the longest distance R2 of the bottom flange, or respectively to the largest diameter D1, which normally is doubled with respect to the longer distance R2, either perpendicular or rotated for the degree of the toe-out angle K. Said longer distance R2 of the anti-slip stud bottom flange 22 extends to outside the envelope curve E, drawn around the jaw fingers 3, 4, 5, 6, but not more than for the distance of the second tolerance T2, in a situation where the anti-slip stud is positioned in the mutual interval 17 of the jaw fingers, as is seen in FIG. 14, which provides for a flexible insertion of the anti-slip stud in the stud recess together with the bottom flange bevel 25. The hard cermet piece 27 is composed of any sufficiently hard and otherwise appropriate material, known or new, generally sintered material, such as metal carbides, metal nitrides, metal oxides etc. On the other hand, the stud body, comprising the bottom flange 22, the top bowl and the neck portion 23, can be made, in a prior art method or in a new method, of some suitable metal alloy, such as a steel or an aluminum, or it can be made of a plastic or of a composite material. The invention neither relates to the material of the hard cermet piece as such, nor to the material of the body as such, and therefore they are not described in more detail here, and the above mentioned materials shall be understood as examples only.

Apart from being quadrangular, said hard cermet piece 27 of the anti-slip stud 20 can advantageously also be triangular, in which case it has, when observed in cross-section, three concave sides 36 and three planar or outwardly convex edges 28. These concave sides 36 have side spans S1, and the edges have angular spans S2, and both of said spans are measured between the transition points 38 of the plane or rounding of the edges 28 and the concavity of the sides. The transition points 38 are unambiguous, because at them, when moving along the outer surface of the hard cermet piece along the curvature of the surface, which as known is the derivative of the tangent of the directional angle with respect to curve length, there is either a sudden change, or then its sign changes. According to the invention, the ratio S1:S2 of the side spans to the angular spans is not more than 4:1 but at least 0.8, or preferably not more than 3:1 but at least 1.2:1. The concave sides 36 of the hard cermet piece have curvature radii R_{S} that are at least half of but not more than three times as long as the radius R_{R} of the circle drawn around the hard cermet piece, which radius at the same time is equal to the three longest hard cermet radii R_{R} of the triangular hard cermet piece 27 from the stud center line 30. The edges 28 of the hard cermet piece have a radius of curvature R_{C}, which thus can be infinite, forming planar edges, but generally it is smaller and forms outwardly convex edges, in which case the radius of curvature R_{C} is at least half of the angular span S2, but not more than twice the radius R_{R} of the circle drawn around the hard cermet piece, or preferably R_{C} is within the range 1×S2−1.5×R_{R}. For the orientation of the anti-slip stud, particularly in this case, also the bottom flange 22 is advantageously triangular and has three longest flange radii R_{D}, and the hard cermet radii R_{R} are either parallel with the flange radii R_{D}, or parallel with the center lines C of the flange radii R_{D}. In addition, the anti-slip stud top bowl 21 is triangular in cross-section. The triangular shape of the bottom flange and the top bowl gives a better support for the anti-slip stud 20 in the tire tread 41, with the same degree of tightening as in the other variations. This kind of anti-slip studs with a triangular hard cermet piece and a triangular bottom flange can also be installed and orientated in the tire tread, so that the largest width D3 of the hard cermet piece forms a toe-out angle K in a way to be described below.

The above described combination is used by applying the following process steps according to the invention. Let us take an air-filled vehicle tire 40, the tread 41 of which is provided with a number of premade stud recesses 43. The narrowing tip portions 7 of the jaw fingers 3 or 4 or 5 or 6 of the installation tool 1 are pressed in, starting from the situation of FIG. 16A, where the jaw fingers are placed outside the tread 41, in the direction F1, in one of the stud recesses 43 at a time, i.e. to the situation of FIG. 16B, when the jaw fingers are at the same time radially shifted T towards their mutual jaw center line 10, to their inner position B1, typically to get in mutual contact according to FIGS. 16A-16B. Next there is fed in an anti-slip stud 20 of the type described above, provided with a top bowl 21 and an oval or polygonal bottom flange 22 that is at least partly wider than the top bowl, as well as a narrower neck portion 23 therebetween, so that the bottom flange proceeds ahead along the mutual interval 17 of the jaw fingers in the direction F2, by means of the plunger pin 11 and the force F into the stud recess. In this connection, the jaw fingers 3, 4, 5, 6 are shifted, in the direction T of the radius, outwardly thus expanding the stud recess 43, so that the anti-slip stud fits in said stud recess without difficulty, further in the direction F2, as is seen in FIGS. 14 and 16C. When the jaw fingers 3, 4, 5, 6 expand the stud recess 43 outwardly from the jaw center line 10, in the directions T of the radius, first nearer to the bottom expansion of the stud recess, by the tip portions 7 of the jaw fingers, and expand the stud recess further nearer to the tire rolling surface 42 and at said surface, by the cross-section AMAX of the top point 15 that is larger than the tip portion of the jaw fingers. The smaller, expanded area of the stud recess is seen in FIG. 14 as a non-cross-sectional surface marked by a dotted line and bordered by a first envelope curve E1, and the larger expansion of the stud recess, located near the rolling surface, is seen as a cross-sectional surface marked by a dotted line and bordered by a second envelope curve E2. During operation, there is used the common reference number E for the changing envelope curves, and envelope curve E1 and E2 are special cases of these curves. As is seen, in this case the triangular bottom flange 22 of the anti-slip stud fits into the stud recess that is expanded to the width of the second envelope curve E2, although the edge portions 33 of the bottom flange are still placed between the jaw fingers 3. All that is explained here also applies to other bottom flange shapes according to the invention, and to all jaw finger numbers N according to the invention. Next the anti-slip stud 20 is held by said plunger pin 11 in the stud recess, and at the same time the jaw fingers 3, 4, 5, 6 are pulled out of the stud recess in the direction F3 from around the anti-slip stud, as is seen in FIG. 16D. Finally we proceed to install the next anti-slip stud 20 in the next stud recess 43, again by following the above described steps according to FIGS. 16A-16D, or the installation of the studs in the tire in question is terminated, if the stud in question was the last stud to be installed.

The above described arrangement according to the invention is particularly well suited for the installation of studs that can be orientated and in the installation of anti-slip studs that can be orientated. In the first alternative, there are used anti-slip studs 20 provided with a non-round hard cermet piece 27 that on the cross-sectional surface is perpendicular to the stud center line 30, so that the shape of said hard cermet piece is in a constant position with respect to the shape of the bottom flange 22, i.e. that in every used stud 20, the longest diameter D3 or largest width D3 of the hard cermet piece 27 is located in the same predetermined position in relation to the longest diameter D1 of the bottom flange, as is seen in FIGS. 5-8 and 11-13. Normally the largest diameter and width D3 is either perpendicular to or parallel with the largest diameter D1 of the bottom flange. In order to install such anti-slip studs in an orientating way, at least the jaw fingers 3, 4, 5, 6 of the installation tool 1 are rotated around their jaw center lines 10 for the measure of the toe-out angle K, as marked by dotted lines in FIG. 15 and in FIGS. 1A and 3A in relation to FIG. 2. Now the installed anti-slip studs 20 are turned around their stud center lines 30 for the measure of the toe-out angle K, because the jaw fingers force the bottom flange 22 to turn along for the same toe-out angle, so that the hard cermet pieces 27 are orientated in the tire in a predetermined position with respect to said rotation axis line P2. Secondly, in said alternative there are used such mutually different anti-slip studs 20 of which in the first type of studs the shape of the hard cermet piece is turned for the measure of the toe-out angle K in relation to the shape of the bottom flange 22, and of which in the second type of studs said toe-out angle does not exist. In the first type of anti-slip studs 20, the longest diameter D3 or largest width D3 of the hard cermet piece 27 is typically located either in parallel with or perpendicular to the longest diameter D1 of the bottom flange, as is seen in FIGS. 2 and 5-8, as well as 11-13, and in the second type of anti-slip studs 20, the longest diameter D3 or largest width D3 of the hard cermet piece 27 is located as turned for the measure of the toe-out angle K in relation to the longest diameter D1 of the bottom flange or in relation to a line perpendicular to the longest diameter D1, as is seen in FIGS. 11B and 3B, as well as 9-10. Now at least the mutual positions of the jaw fingers 3, 4, 5, 6 of the installation tool 1 are maintained, in directions perpendicular to the jaw center line 10, in a constant position with respect to the rotation axis line P2, but the first type of anti-slip studs to be installed are replaced by the second type of anti-slip studs or vice versa, i.e. the type of the anti-slip studs to be installed is changed in order to orientate the studs in a predetermined position with respect to said rotation axis line P2.

In the vehicle tire tread 41, the anti-slip studs 20 may according to a preferred embodiment be arranged in only one position, so that all studs are in the position seen in FIG. 2, where the longest diameter D3 or largest width D3 of the hard cermet piece 27 is essentially transversal to the circumferential rotation direction P1, i.e. essentially parallel with the rotation axis line P2. At the same time, particularly as regards a nearly triangular hard cermet piece 27, one of its hard cermet radii RR is perpendicular to the rotation axis line, either in the tire rotation direction P1 or in the opposite direction, because in that case the largest width D3 between the adjacent edges 28 is parallel with the rotation axis line P2. At the moment it is believed that the most economical way is to arrange one of the hard cermet radii RR in an opposite direction than the rotation direction P1, in which case the largest width D3, when the tires rotate, hits first the road surface, but when braking, crushed ice is removed to the sides 36 of the hard cermet piece 27 owing to the effect of the concave shape, and is not wedged under the stud, which would lift the stud at the same time as the largest width D3 divides the braking force in a large area. In particular anti-slip studs provided with a quadrangular hard cermet piece, but probably also with a triangular hard cermet piece, are advantageously arranged in the tire tread, in various positions according to a second embodiment, generally in at least two, but preferably in three or more positions in the way illustrated in FIGS. 1A-4. Thus the anti-slip studs typically include at least two first groups J1_{A} and J1_{B} located nearer to the tire shoulders, and at least one second group J2 located nearer to the tire center parts, so that the studded tire is in the width direction of the tread made symmetrical with respect to the studding when desired. It also is possible to use only one first group J1_{A} or J1_{B} nearer to one shoulder of the tire, and at least one second group J2 nearer to the center parts of the tire and the opposite shoulder, so that a studded tire is in the width direction of the tread made asymmetrical with respect to the studding when so desired. The surface patterns proper of the tread 41 can irrespective of the studding be symmetrical or asymmetrical in a known fashion. According to the invention, in the first groups J1_{A} and J1_{B} of the anti-slip studs, one of the largest diameters or widths D3 of the hard cermet pieces is located at said toe-out angle K with respect to the rotation axis line P2, as is seen in FIGS. 1A-1B, 3A-3B and 4, and in the second group J2 of the anti-slip studs, one of the largest diameters or widths D3 of the hard cermet pieces is located essentially in parallel with the rotation axis line P2, as is seen in FIGS. 2 and 4. In any case, the toe-out angles are in the second group J2 smaller than in the first group or groups J1_{A}, J1_{B}. In the first groups J1_{A}, J1_{B}, the toe-out angle K is smaller than 30°, but typically not more than 20° and preferably not more than 15°. There are, however, situations where the applied toe-out angles K are not more than 10°. In the second groups the toe-out angles K are smaller than 15° and typically smaller than 10°, preferably approaching the value 0° of the toe-out angle. In case the tire includes third groups—not illustrated—in between said first and second groups that can naturally be interlacing with one or both of the above described groups, there are advantageously used toe-out angles K that fall in between, such as for example within the range 10°-15°. In the first group or groups, the toe-out angles K can be orientated in any direction, i.e. outwards or inwards from the center line 50 of the width of the tread 41, in a case where the tread pattern represents a type that can in a vehicle be arranged to rotate in any direction, and by which the rotation direction thus is either one of the opposite circumferential directions. On the other hand, in a case where the tread pattern represents a type that requires a given predetermined rotation direction, i.e. the tire must be arranged in the vehicle so that the rotation direction is always the same when driving forward, there can be used an even more effective method for toe-out setting. In that case, in the first groups J1_{A} and J1_{B}, the toe-out angles K of the single long diameters D3 or large widths D3 of the hard cermet pieces are directed, in comparison with the rotation axis line P2, forward in the rotation direction P1, i.e. in the rotation direction. In FIGS. 1A-1B and 3A-3B, the rotation direction P1 points downwardly, and now the toe-out angles K that open in the direction of the shoulders, which angles thus are angles between the longest diameter D3 or the largest width D3 of the hard cermet piece and the rotation axis line P2, are always positioned underneath the line that is parallel to the rotating axis and passes via the center line 30 of said anti-slip stud 20, in one direction in group J1_{A} and in the opposite direction in group JIB. There can also be several such groups, for instance five, so that the studs 20 belonging to a group located nearest to the shoulders can have the widest toe-out setting, the middle group does not have a toe-out setting at all, as was explained above, and the studs 20 belonging to a group located between said groups have a narrower toe-out setting than the studs located near the shoulders. It also is possible to arrange such additional groups of anti-slip studs 20 where the studs have a toe-out setting in a different direction than what was explained above. Said first stud groups J1_{A}, J1_{B} and said second stud group J2, i.e. those tire tread areas where there are studs that satisfy the conditions in question, may be located completely separately from each other, or the areas may be exactly bordered by each other. In practice it may be most sensible that for example the first groups J1_{A}, J1_{B} are arranged in an interlacing fashion with respect to the second group J2, when these groups are observed, as in FIG. 4, as width-orientated tire zones, bordered in the width direction by the outermost studs 1 that satisfy the toe-out condition of said group, so that the toe-out angle K has a given, predetermined value, or the toe-out angle K falls within a given predetermined angle range.

1. A combination for installing anti-slip studs, said combination comprising:
an air-filled vehicle tire, provided with a tread with a rolling surface;
anti-slip studs provided with an outer head and an inner head, and in the inner head a bottom flange and in the outer head a top bowl, the bottom flange in the tread being deeper from the rolling surface and the top bowl being nearer to the rolling surface; said anti-slip studs having a stud length and a stud center line parallel to said stud length, and the bottom flange having a cross-sectional shape perpendicular to the stud center line, which cross-sectional shape is composed of: a number of at least two first side portions with center regions at a shorter distance from said stud center line, and a number of at least two second side portions with center regions at a longer distance from said stud center line; and
an installation tool by which said anti-slip studs are installed in said tread, said combination further comprising:
a plurality of premade stud recesses in said tread;
a number of jaw fingers in said installation tool, which number is equal to twice the number of said second side portions; and
said jaw fingers being in contact with at least two such first side portions of the bottom flange of the anti-slip stud where said center regions are located at a shortest distance from said stud center line, in order to keep the bottom flange and hence the anti-slip stud in a predetermined constant position between said jaw fingers.

2. A combination according to claim 1, wherein the number of said second side portions is two, and the number of said jaw fingers is four.

3. A combination according to claim 1, wherein said second side portions are gradually or steplessly changing into said first side portions.

4. A combination according to claim 3, wherein said second side portions and said first side portions together form an oval.

5. A combination according to claim 1, further comprising a separate hard cermet piece in said anti-slip stud, which hard cermet piece extends from said outer head to at least the length of the top bowl, and has a non-round cross-sectional shape in a plane perpendicular to the stud center line.

6. A combination according to claim 5, wherein said non-round cross-sectional shape of the hard cermet piece is: substantially elongate, having a largest width and being located in the anti-slip stud either so that said largest width is perpendicular to the longer distance of the bottom flange, or so that said largest width is turned by a toe-out angle.

7. A combination according to claim 1, wherein said stud recesses have a bottom expansion for the bottom flange of the anti-slip studs, said bottom expansion having a shape that is substantially similar to that of the bottom flange.

8. A combination according to claim 1, wherein said stud recesses have an at least partly circular inner surface with hole diameters.

9. A combination according to claim 1, wherein said jaw fingers of the installation tool have a jaw length that is substantially longer than the stud length of the anti-slip studs, and a mutual jaw center line that substantially concurs with the center line of the anti-slip studs to be installed.

10. A combination according to claim 9, wherein said jaw fingers are radially movable towards said jaw center line and away therefrom.

11. A combination according to claim 8, wherein said jaw fingers have tip portions that jointly form, when the jaw fingers are in a position shifted towards said jaw center line and in mutual contact, a transversal tip dimension, which is larger than said hole diameter, but not more than a first tolerance.

12. A combination according to claim 11, wherein said jaw fingers have cross-sections that are radially getting larger from said tip portions in the direction of the jaw lengths with respect to the jaw center line.

13. A combination according to claim 9, said installation tool further comprising a plunger pin movable in the direction of said jaw center line and to enter a mutual interval of the jaw fingers, while the jaw fingers are radially moved away from each other.

14. A combination according to claim 1, wherein said longer distance of the anti-slip stud bottom flange extends to outside an envelope curve drawn around the jaw fingers, but not more than a second tolerance, in a situation where the anti-slip stud is in a mutual interval of the jaw fingers.

15. A combination according to claim 1, wherein said bottom flange has beveled edges.

16. A combination for installing anti-slip studs, said combination comprising:
an air-filled vehicle tire, provided with a tread with a rolling surface, and a plurality of premade stud recesses in the tread;
anti-slip studs, provided with an outer head and an inner head, and in the inner head a bottom flange and in the outer head a top bowl, the bottom flange in the tread being deeper from the rolling surface and the top bowl being nearer to the rolling surface; said anti-slip studs having a stud length and a stud center line parallel to said stud length, and the bottom flange having a cross-sectional shape perpendicular to the stud center line, which cross-sectional shape is composed of: a number of at least two first side portions with center regions at a shorter distance from said stud center line, and of a number of at least two edge portions; and
an installation tool by which said anti-slip studs are installed in said tread,
said combination further comprising:
a number of jaw fingers in said installation tool, which number is equal to the number of said edge portions; and
said jaw fingers being in contact with at least two such first side portions of the bottom flange of the anti-slip stud where said center regions are located at a shortest distance from said stud center line, in order to keep the bottom flange and hence the anti-slip stud in a predetermined constant position between said jaw fingers.

17. A combination according to claim 16, wherein the number of said edge portions is at least three but no more than six.

18. A combination according to claim 16, wherein the number of said edge portions is:
three and the number of said jaw fingers is three or four; or
four and the number of said jaw fingers is four; or
five and the number of said jaw fingers is five; or
six and the number of said jaw fingers are six.

19. A combination according to claim 16, wherein said edge portions have a radius of curvature.

20. A combination according to claim 16, wherein said first side portions are convex or straight or concave.

21. A combination according to claim 16, further comprising a separate hard cermet piece in said anti-slip stud, which hard cermet piece extends from said outer head to at least the length of the top bowl, and has a non-round cross-sectional shape in a plane perpendicular to the stud center line.

22. A combination according to claim 21, wherein said non-round cross-sectional shape of the hard cermet piece is: substantially a triangle or a quadrangle or a pentagon or a hexagon, having a largest diameter and being located in the anti-slip stud either substantially in the same position with respect to a triangular or quadrangular or pentagonal or hexagonal shape of the bottom flange, or so that said largest diameter is turned by a toe-out angle.

23. A combination according to claim 21, wherein the hard cermet piece is triangular in shape and comprises three concave sides and three planar or outwardly convex edges.

24. A combination according to claim 23, wherein said concave sides have side spans, and said edges have angular spans between transition points of edge planes or edge roundings and concavities of said concave sides, whereupon the ratio of the side spans to the angular spans is not more than 4:1 but at least 0.8:1.

25. A combination according to claim 24, wherein the ratio of said side spans to said angular spans is not more than 3:1 but at least 1.2:1.

26. A combination according to claim 23, wherein said concave sides of the hard cermet piece have radii of curvature that are at least half of but not more than three times the radius of a circle drawn around said hard cermet piece.

27. A combination according to claim 24, wherein said convex edges have a radius of curvature that is at least half of said angular span, but not more than twice the radius of a circle drawn around said hard cermet piece.

28. A combination according to claim 23, wherein said triangular hard cermet piece has three longest hard cermet radii, and said bottom flange is triangular having three longest flange radii, whereupon said hard cermet radii are either parallel with the flange radii or parallel with central intervals of the flange radii.

29. A combination according to claim 16, wherein said stud recesses have a bottom expansion for the bottom flange of the anti-slip studs, said bottom expansion having a shape that is substantially similar to that of the bottom flange.

30. A combination according to claim 16, wherein said stud recesses have an at least partly circular inner surface with hole diameters.

31. A combination according to claim 16, wherein said jaw fingers of the installation tool have a jaw length that is substantially longer than the stud length of the anti-slip studs, and a mutual jaw center line that substantially concurs with the center line of the anti-slip studs to be installed.

32. A combination according to claim 31, wherein said jaw fingers are radially movable towards said jaw center line and away therefrom.

33. A combination according to claim 30, wherein said jaw fingers have tip portions that jointly form, when the jaw fingers are in a position shifted towards said jaw center line and in mutual contact, a transversal tip dimension, which is larger than said hole diameter, but not more than a first tolerance.

34. A combination according to claim 33, wherein said jaw fingers have cross-sections that are radially getting larger from said tip portions in the direction of the jaw lengths with respect to the jaw center line.

35. A combination according to claim 31, said installation tool further comprising a plunger pin movable in the direction of said jaw center line and to enter a mutual interval of the jaw fingers, while the jaw fingers are radially moved away from each other.

36. A combination according to claim 16, wherein said longer distance of the anti-slip stud bottom flange extends to outside an envelope curve drawn around the jaw fingers, but not more than a second tolerance, in a situation where the anti-slip stud is in a mutual interval of the jaw fingers.

37. A combination according to claim 16, wherein said bottom flange has beveled edges.

38. A method for installing non-round anti-slip studs in a vehicle tire tread, said method comprising the steps of:
providing an air-filled vehicle tire with a tread and a plurality of premade stud recesses in the tread, said tire having a rotation axis line;
utilizing an installation tool comprising:
a number of at least three jaw fingers provided with narrowing tip portions, said jaw fingers being radially movable along their mutual jaw center line and radially away therefrom, and
a plunger pin that is movable in parallel with the jaw center line and in the mutual interval between the jaw fingers;
inserting said tip portions of the installation tool in said stud recesses, one recess at a time;
entering an anti-slip stud provided with a top bowl and a bottom flange in the mutual interval, so that the bottom flange proceeds foremost;
pressing said anti-slip stud by a plunger pin into the stud recess, along said mutual interval, so that the jaw fingers expand the stud recess;
allowing said plunger pin to hold the anti-slip stud in the recess at the same time as the jaw fingers are pulled out of the stud recess, from around the anti-slip stud; and
proceeding to install the next anti-slip stud in the next stud recess, or terminating the installation of the studs in this tire,
said method further comprising the steps of:
using anti-slip studs of a type having an oval or polygonal bottom flange that is at least partly wider than said top bowl, and with a non-round hard cermet piece arranged on a cross-sectional plane perpendicular to the stud center line, said shape of the hard cermet piece being in a constant position with respect to the shape of the bottom flange; and
turning at least the jaw fingers of the installation tool around the jaw center line by a predetermined toe-out angle or without said toe-out angle in respect to said rotation axis line of the tire,
in order to orientate the hard cermet piece of the studs in a predetermined position in the tire with respect to said rotation axis line.

39. A method for installing non-round anti-slip studs in a vehicle tire tread, said method comprising the steps of:
providing an air-filled vehicle tire with a tread and a plurality of premade stud recesses in the tread, said tire having a rotation axis line;
utilizing an installation tool comprising:
a number of at least three jaw fingers provided with narrowing tip portions, said jaw fingers being radially movable along their mutual jaw center line and radially away therefrom, and
a plunger pin that is movable in parallel with the jaw center line and in the mutual interval between the jaw fingers;
inserting said tip portions of the installation tool in said stud recesses, one recess at a time;
entering an anti-slip stud provided with a top bowl and a bottom flange in the mutual interval, so that the bottom flange proceeds foremost;
pressing said anti-slip stud by a plunger pin into the stud recess, along said mutual interval, so that the jaw fingers expand the stud recess;
allowing said plunger pin to hold the anti-slip stud in the recess at the same time as the jaw fingers are pulled out of the stud recess, from around the anti-slip stud; and
proceeding to install the next anti-slip stud in the next stud recess, or terminating the installation of the studs in this tire,
said method further comprising the steps of:
using anti-slip studs of a type having an oval or polygonal bottom flange that is at least partly wider than said top bowl, and a hard cermet piece that is non-round on the cross-sectional plane perpendicular to the stud center line;
maintaining at least the position of the jaw fingers of the installation tool in a constant position in respect to said rotation axis line of the tire; and
changing the type of the anti-slip studs to be installed, so that studs where the shape of the hard cermet piece is rotated by a predetermined toe-out angle with respect to the shape of the bottom flange are replaced by studs where said toe-out angle does not exist, or vice versa,
in order to orientate the hard cermet piece of the studs in a predetermined position in the tire with respect to said rotation axis line.

40. A combination according to claim 9, wherein said jaw fingers have tip portions that jointly form, when the jaw fingers are in a position shifted towards said jaw center line and in mutual contact, a transversal tip dimension, which is larger than said hole diameter, but not more than a first tolerance.

41. A combination according to claim 31, wherein said jaw fingers have tip portions that jointly form, when the jaw fingers are in a position shifted towards said jaw center line and in mutual contact, a transversal tip dimension, which is larger than said hole diameter, but not more than a first tolerance.
